(19) United States
(12) Patent Application Publication
(10) Pub. No.: US 2005/0276446 A1
(43) Pub. Date: Dec. 15, 2005

(54) Apparatus and method for extracting moving objects from video

(75) Inventors: Maolin Chen, Beijing (CN); Gyu-tae Park, Anyang-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co. Ltd., Suwon-Si (KR)

(21) Appl. No.: 11/149,306

(22) Filed: Jun. 10, 2005

(30) Foreign Application Priority Data
Jun. 10, 2004 (KR) 10-2004-0042540

(51) Int. Cl. G06K 9/00; G06K 9/34

(52) U.S. Cl. 382/103; 382/173

(57) ABSTRACT

A pixel classification device to separate, and a pixel classification method of separating, a moving object area from a video image, the device including a first classification unit to determine whether a current pixel of the video image belongs to a confident background region, and a second classification unit to determine which one of a plurality of sub-divided background areas or the moving object area the current pixel belongs to in response to a determination tht the current pixel does not belong to the confident background region.

### CROSS-REFERENCE TO RELATED APPLICATIONS

This application claims the benefit of Korean Patent Application No. 10-200442540 filed on Jun. 10, 2004, in the Korean Intellectual Property Office, the disclosure of which is incorporated herein by reference.

### BACKGROUND OF THE INVENTION

1. Field of the Invention

The present invention relates to a computer visual system, and, more particularly, to a technique of automatically extracting moving objects from a background on an input video frame.

2. Description of the Related Art

Conventionally, it has been difficult to execute applications that require complicated real-time video processing due to the limited computational ability of computer systems. As a result, most systems using such complicated applications cannot operate in real time because of their slowness, or can only be used in restricted areas, that is, in strictly controlled environments. Recently, however, great improvement in the computing speed of computers has enabled the development of more complex and elaborate algorithms for real-time interpretation of streaming data. Therefore, it has become possible to model actual visual worlds existing under various conditions.

A technique of extracting moving objects from a video sequence has been proposed to perform real-time video processing. This technique is used in various visual systems, such as video monitoring, traffic monitoring, person counting, video edition, and the like. Typically, background subtraction is used to distinguish moving objects from a background scene. In background subtraction, portions of a current image that also appear in a reference image obtained from a background kept static for a certain period of time are subtracted from the current image. Through this subtraction, only moving objects or new objects remain on a screen.

Although the background subtraction technique has been used in many visual systems for several years, it cannot properly cope with an overall or partial illumination change, such as a shadow or a highlight. Furthermore, background subtraction cannot adaptively cope with various environments, such as environments in which an object moves slowly, an object is incorporated into a background and removed from the background, and the like.

Various attempts to solve these problems of the background subtraction technique have been made. Examples of the attempts include: a method of distinguishing between an object and a background by measuring a distance between a stereo camera and the object using the stereo camera (which is disclosed in U.S. Pat. No. 6,661,918; hereinafter, referred to as the '918 patent); a method of determining an object as a moving object when a difference between colors of the object and a fixed background in each pixel exceeds a critical value (which is disclosed in CVPR 1999, C. Stauffer; hereinafter, referred to as the Stauffer method); and a method of distinguishing a shadow area and a highlight area from a general background area by dividing a color into a luminance signal and a chrominance signal (which is disclosed in ICCV Workshop FRAME-RATE 1999, T. Horprasert; hereinafter, referred to as the Horprasert method).

In the Stauffer method, an adaptive background mixture model is produced by learning a background which is fixed for a significant period of time and used for real-time tracking. In the Stauffer method, a Gaussian mixture model for a background is selected for each pixel, and a mean and a variance of each Gaussian model are obtained. According to this statistical method, a current pixel is classified as a background or a moving object according to how similar the current pixel is to a corresponding background pixel.

As illustrated in FIG. 1, either a compact boundary or a loose boundary may be used depending on a critical value, and on this basis the degree of similarity is determined. In FIG. 1, a pixel model is represented in a coordinate plane with two axes, which are a red (R) axis and a green (G) axis. The pixel model may be represented as a ball in a three-dimensional RGB space. An area inside a solid boundary circle denotes a collection of pixels selected as a background, and an area outside the solid boundary circle denotes a collection of pixels selected as a moving object. Hence, pixels existing between the compact boundary and the loose boundary are recognized as a moving object when the compact boundary is used, or recognized as a background when the loose boundary is used.

FIGS. 2A-2C show different results of extracting a moving object depending on the degree of strictness of a boundary used in the Stauffer method. FIG. 2A shows a sample image, FIG. 2B shows an object extracted from the sample image when the compact boundary is used, and FIG. 2C shows an object extracted from the sample image when the loose boundary is used. When the compact boundary is used, a shadow area is misrecognized as a foreground. When the loose boundary is used, the shadow area is properly recognized as a background, but a portion that should be classified as the moving object is misrecognized as the background.

In the Horprasert method, as illustrated in FIG. 3, a pixel is represented with a luminance (L) and a chrominance (C). In a two-dimensional LC space, a moving object area F, a background area B, a shadow area S, and a highlight area H are determined through learning over a significantly long period of time. It is determined that a current pixel has properties of an area to which the current pixel belongs.

However, as illustrated in FIG. 4, when a camera having an automatic iris is used, and a frame is highlighted, a problem arises that cannot be solved by the Horprasert method. In the Horprasert method, as illustrated in FIG. 4, chrominance upper limits of a shadow area (a), a highlight area (b), and an area (c) changed by an effect of the automatic iris are determined to be a single chrominance line. Accordingly, pixels exceeding the upper limits may be misclassified into a moving object. This problem cannot be solved as long as an identical upper limit is applied to areas other than a moving object area.

### SUMMARY OF THE INVENTION

The present invention provides a system to accurately extract a moving object under various circumstances in which a shadow effect, a highlight effect, an automatic iris effect, and the like, occur.

The present invention also provides a moving object extracting system which robustly and adaptively copes with an abrupt change of illumination of a scene.

The present invention also provides a background model which is adaptively controlled in real time for an image that changes over time.

Additional aspects and/or advantages of the invention will be set forth in part in the description which follows and, in part, will be apparent from the description, or may be learned by practice of the invention.

According to an aspect of the present invention, there is provided a pixel classification device to automatically separate a moving object area from a received video image. This device includes a pixel sensing module to capture the video image, a first classification module to determine, according to Gaussian models, whether a current pixel of the video image belongs to a confident background region, and a second classification module to determine which one of a plurality of sub-divided shadow areas, a plurality of sub-divided highlight areas, and the moving object area the current pixel belongs to, in response to a determination that the current pixel of the video image does not belong to the confident background region.

According to another aspect of the present invention, there is provided a moving object extracting apparatus including a background model initialization module to initialize parameters of a Gaussian mixture model of a background and to learn the Gaussian mixture model during a predetermined number of frames of a video image, a first classification module to determine whether a current pixel belongs to a confident background region according to whether the current pixel is included in the Gaussian mixture model, a second classification module to determine which one of a plurality of sub-divided shadow areas, a plurality of sub-divided highlight areas, and a moving object area the current pixel belongs to, in response to a determination being made that the current pixel does not belong to the confident background region, and a background model updating module to update the Gaussian mixture model in real time according to a result of the determination as to whether the current pixel belongs to the confident background region.

According to still another aspect of the present invention, there is provided a pixel classification method of automatically separating a moving object area from a received video image, the method including capturing the video image, determining, according to Gaussian models, whether a current pixel of the video image belongs to a confident background region, and determining which one of a plurality of sub-divided shadow areas, a plurality of sub-divided highlight areas, and the moving object area the current pixel belongs to, in response to a determination that the current pixel of the video image does not belong to the confident background region.

According to yet another aspect of the present invention, there is provided a moving object extracting method including initializing parameters of a Gaussian mixture model of a background and learning the Gaussian mixture model during a predetermined number of frames of a video image, determining whether a current pixel belongs to a confident background region according to whether the current pixel is included in the Gaussian mixture model, determining which one of a plurality of sub-divided shadow areas, a plurality of sub-divided highlight areas, and the moving object area the current pixel belongs to, in response to a determination being made that the current pixel does not belong to the confident background region, and updating the Gaussian mixture model in real time according to a result of the determination as to whether the current pixel belongs to the confident background region.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a compact boundary and a loose boundary.

FIGS. 2A-2C illustrate different results of extraction of a moving object depending on the degree of strictness of a boundary in the Stauffer method.

FIG. 3 illustrates an area classification boundary in the Horprasert method.

FIG. 4 illustrates a misrecognized area produced in the Horprasert method.

FIG. 5 is a block diagram of a moving object extracting apparatus according to an embodiment of the present invention.

FIG. 6 is a graph illustrating an example of a Gaussian mixture model for one pixel.

FIG. 7 is a graph illustrating a first classification basis.

FIG. 8 illustrates a method of dividing an RGB color into two components.

FIG. 9 is a classification area table obtained by indicating classification areas on an LD-CD coordinate plane according to an embodiment of the present invention.

FIGS. 10A and 10B are graphs illustrating a method of determining a critical value of a sub-divided area.

FIGS. 11A through 11E are graphs illustrating examples of sample distributions for sub-divided areas.

FIG. 12 is a flowchart illustrating an operation of the moving object extracting apparatus 100 of FIG. 5.

FIG. 13 is a flowchart illustrating a background model initialization process.

FIG. 14 is a flowchart illustrating an event detection process.

FIGS. 15A-15D illustrate a result of extraction of moving objects according to an embodiment of the present invention in addition to the extraction results of FIG. 2.

FIGS. 16A and 16B are graphs illustrating results of experiments according to an embodiment of the present invention and according to a conventional Horprasert method under several circumstances.

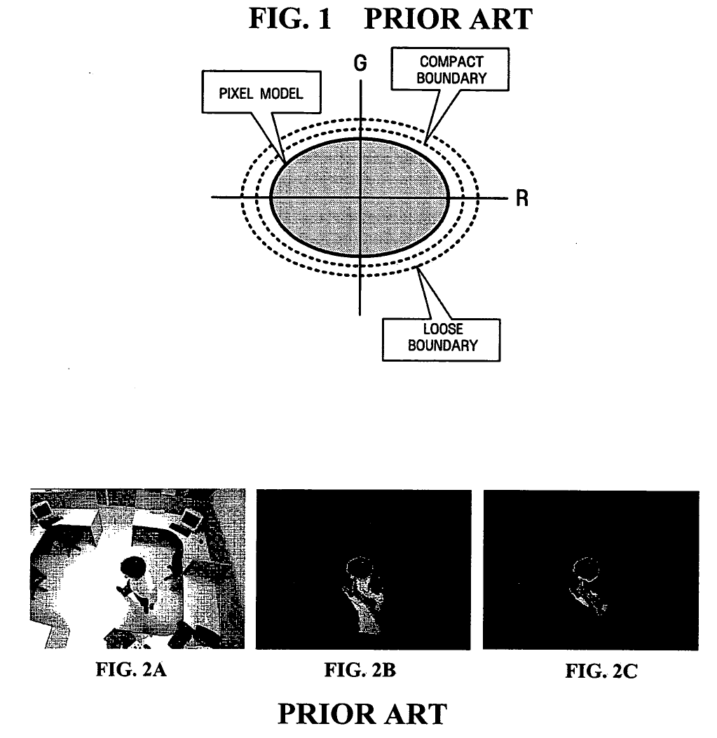

### DETAILED DESCRIPTION OF THE PREFERRED EMBODIMENTS

Reference will now be made in detail to the following embodiments of the present invention, examples of which are illustrated in the accompanying drawings, wherein like reference numerals refer to the like elements throughout. The embodiments are described below to explain the present invention by referring to the figures. The present invention may, however, be embodied in many different forms, and should not be construed as being limited to the embodiments set forth herein. Rather, these embodiments are provided so that this disclosure will be thorough and complete and will fully convey the concept of the invention to those skilled in the art, and the present invention will only be defined by the appended claims.

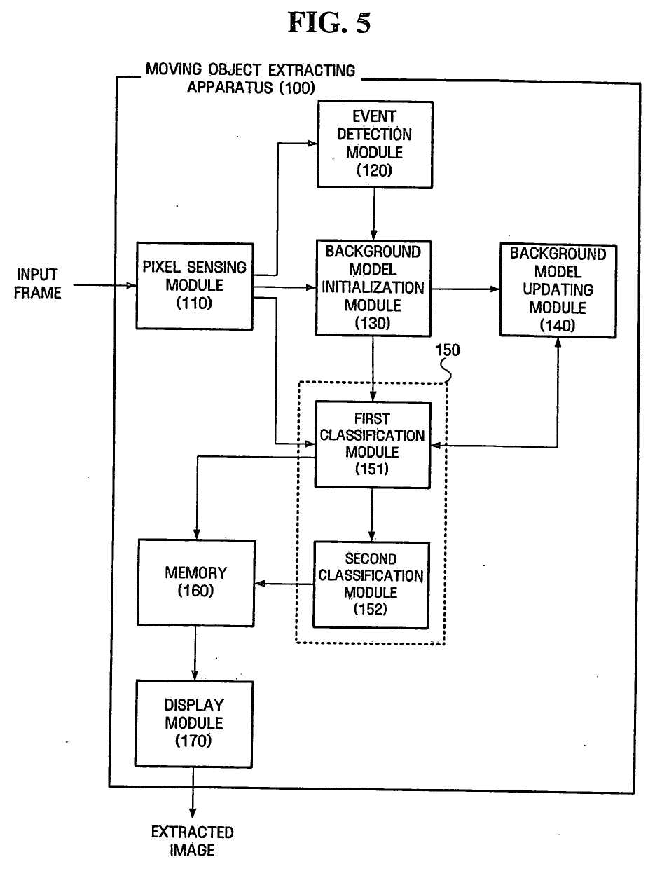

FIG. 5 is a block diagram of a moving object extracting apparatus 100 according to an embodiment of the present invention. The moving object extracting apparatus 100 includes a pixel sensing module 110, an event detection module 120, a background model initialization module 130, a background model updating module 140, a pixel classification module 150, a memory 160, and a display module 170.

The pixel sensing module 110 captures an image of a scene and receives digital values of individual pixels from the image. The pixel sensing module 110 may be considered as a camera comprised of a charged-coupled device (CCD) module to convert a pattern of incident light energy into a discrete analog signal, and an analog-to-digital conversion (ADC) module to convert the analog signal into a digital signal. Typically, the CCD module is a memory arranged so that the output of one semiconductor serves as the input of a neighboring semiconductor, and the CCD module can be charged by light or electricity. The CCD module is typically used in digital cameras, video cameras, optical scanners, and the like, to store images.

The background model initialization module 130 initializes parameters of a Gaussian mixture model for a background, and learns a background model during a predetermined number of frames.

When a stationary camera is used, that is, when a background does not change, the captured image may be affected by noise, and the noise may be modeled as a single Gaussian. However, in an actual environment, an adaptive Gaussian mixture model generally has multiple distributions for each pixel to properly cope with a change in brightness.

As for the Gaussian mixture model, for a predetermined period of time, a value of a gray pixel is obtained as a scalar and a value of a color pixel is obtained as a vector. A value I of a specific pixel {x, y} determined at a certain time t denotes a history of the pixel {x, y} as shown in Equation 1:
{X₁, X₂ . . . , Xₜ}={I(x,y,i)|1≦i≦t} (1)
wherein X₁, . . . , Xₜ denote frames observed for the predetermined period of time.

A number, K, of Gaussian mixture distributions are used to approximate signals representing recently observed distributions. The value K is determined by available memory and computing ability and may be in the range of about 1 to 5. In Equation 1, i denotes an index for each of the K Gaussian distributions. A probability that a current pixel can be observed is calculated using Equation 2:

$$P ( {X}_{t} ) = {\sum }_{i = 1}^{K} {ω}_{i} \times η ( {X}_{t} , {μ}_{i} , {Σ}_{i} ) \qquad ( 2 )$$

wherein K denotes a Gaussian numeral, ωᵢ denotes the weight of an i-th Gaussian distribution at a time t, and μᵢ, and Σᵢ denote a mean and a covariance matrix, respectively, of the i-th Gaussian distribution. K is appropriately selected in consideration of all scene characteristics and calculation amounts. η(Xₜ, μ, Σ) denotes a Gaussian distribution function and is expressed as in Equation 3:

$$η ( {X}_{t} , μ , Σ ) = \frac{1}{{( 2 π )}^{n / 2} {\vert Σ \vert}^{1 / 2}} {ⅇ}^{- 1 / 2 {( {X}_{t} - u )}^{t} {Σ}^{- 1} ( {X}_{t} - u )} \qquad ( 3 )$$

The above-described Gaussian mixture model is initialized by the background model initialization module 130. The background model initialization module 130 receives pixels from a fixed background and initializes various parameters of the pixels model. The fixed background denotes an image photographed by a stationary camera where no moving objects appear. The initialized parameters are the weight of a Gaussian distribution, ωᵢ, the mean thereof, μᵢ, and the covariance matrix thereof, Σᵢ. These parameters are determined for each pixel.

Initial values of parameters of an image may be determined in many ways. If a similar image already exists, parameter values of the similar image may be used as the initial values of the parameters. The initial values of the parameters may also be determined by a user based on his or her experiences, or may be determined randomly. The reason why the initial values of the parameters may be determined in many ways is that the initial values rapidly converge to actual values through a subsequent learning process, even though the initial values may be different to the actual values.

The background model initialization module 130 learns a background model by receiving an image a predetermined number of times and updating the initialized parameters of the image. A method of updating the parameters of the image will be detailed in a later description of an operation of the background model updating model 140. Although it is preferable that an image with a fixed background is used in the learning of the background model, it is generally very difficult to obtain the fixed background. Consequently, an image including a moving object may be used. The background model initialization module 130 may read the contents of a ‘SceneSetup.ini’ file to determine whether background model learning is to be performed, and to determine a minimum number of times required to learn the background model. The contents of the ‘SceneSetup.ini’ file may be represented as in Table 1:

TABLE 1

[SceneSetup]
LearnBGM=1
MinLearnFrames=120

‘LearnBGM’, which is a Boolean parameter, informs the background model initialization module 130 of whether a background model needs to be learned. When ‘LearnBGM’ is set to 0 (false), the background model initialization module 130 does not perform a process of reading a background image and learning a new model for the background image. When ‘LearnBGM’ is set to 1 (true), the background model initialization module 130 learns a new model from as many frames of an image as are indicated by ‘MinLearnFrames’. Typically, an algorithm can produce an accurate Gaussian model using 30 frames having no moving objects. However, it is difficult for a user to know the minimum number of learning frames precisely, so the user may propose a rough guide.

If a moving object can be removed from a target of observation for at least 30 frames, ‘LearnBGM’ is set to 0, and ‘MinLearnFrames’ is not used. If the target of observation has an object that moves at a constant speed, ‘LearnBGM’ is set to 1, and ‘MinLearnFrames’ varies according to the degree to which a scene is crowded. When there are one or two objects in a scene, a selection of about 120 frames is typically preferable. However, determining the exact number of frames for producing an accurate model is difficult if the target of observation is crowded or moves very slowly. In this case, a method of simply selecting a significantly large number and checking the suitability of the selected number by referring to an extracted background image is used.

As described above, when background model learning repeats for a predetermined number of frames, parameters that have converged, namely, the weight ωᵢ, the mean μᵢ, and the covariance Σᵢ, can be found, and a Gaussian mixture model for a background can be determined using the foreground parameters.

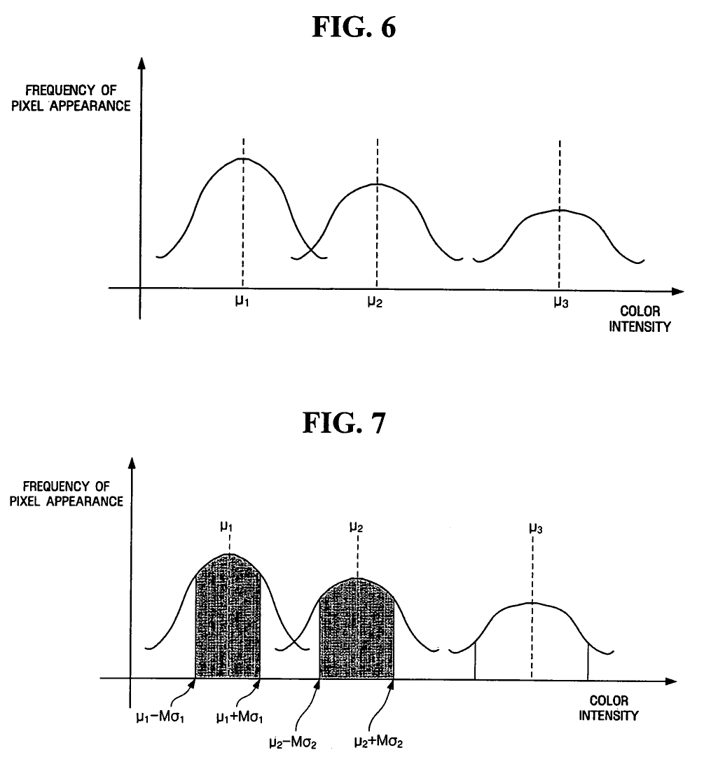

FIG. 6 illustrates an example of a Gaussian mixture model for one pixel. The number of Gaussian distributions, K, is 3, and a weight of each Gaussian distribution is determined in proportion to the frequency with which the pixels appear. Also, a mean and a covariance of each Gaussian distribution are determined according to statistics. In FIG. 6, a color intensity of a gray color is represented as a single value, that is, a luminance value. As for a color, individual Gaussian distributions are determined for R, G, and B components.

Referring back to FIG. 5, the event detection module 120 sets a test area for a current frame and selects an area where color intensities of pixels have changed from the color intensities of pixels in the test area. When a percentage of the selected area occupied by the number of pixels having changed depths is greater than a critical value rd, a counter value is incremented. Thereafter, when the counter value is greater than a critical value N, it is determined that an event has occurred. Otherwise, it is determined that no events have occurred. An event denotes a circumstance in which the illumination of a scene changes suddenly. Examples of the circumstance may be a situation in which a light illuminating the scene is suddenly turned on or off, a situation where sunlight is suddenly incident or blocked, and the like.

The test area denotes a rich-texture area on the current frame that is preset by a user. The rich-texture area is defined because a stereo camera used to determine a pixel depth relies more on the rich-texture area, that is, a complicated area where luminance variations of pixels are large.

Whether a color of a current pixel has changed may be determined according to whether the color is included in a statistically formed Gaussian distribution for a background color. Similarly, whether a depth of a current pixel has changed may be determined according to whether the depth is included in a statistically formed Gaussian distribution for a background depth. In contrast, with a plurality of Gaussian distributions existing for the background color, a single Gaussian distribution exists for the background depth.

The determination as to whether the color of the current pixel is included in the Gaussian distribution for the background color is made in the same manner as a determination made by a first classification module 151 to be described later. If it is determined that the color of the current pixel is not included in the Gaussian distribution for the background color, it is determined that the color intensity of the current pixel has changed.

Thereafter, the event detection module 120 counts the number of pixels having changed depths among the pixels having changed color intensities on the test area, and determines whether a percentage of the area where the color intensities have changed occupied by the counted number of pixels is greater than the critical value rd (e.g., 0.9). If the percentage is greater than the critical value rd, it can be determined that an event has occurred in the current frame.

On the other hand, when the color intensities of pixels have changed in the current frame, but the depths of the pixels have not changed, this change in the current frame may not be due to an event that has actually occurred but may simply be due to noise or other errors. Hence, if it is considered that an event has occurred in the current frame, the counter value is incremented by one, and another determination as to whether a current accumulated counter value exceeds the critical value N is made. If the current accumulated counter value exceeds the critical value N, it is determined that an event has actually occurred. On the other hand, if the current accumulated counter value does not exceed the critical value N, it is determined that no events have occurred.

When an event is detected based on the above-described conditions, a moving object should be classified according to a new background. Accordingly, the background model initialization module 130 performs a new initialization process. In this case, the initial values of the parameters used before an event occurs may be used as initial values of parameters for the new initialization process. However, instead of using initial values that have converged to incorrect values according to a certain rule, the use of random values as initial parameter values for the new initialization process may reduce the time required to learn a background model.

As described above, the event detection module 120 is used to cover an exceptional case where the illumination of a scene suddenly changes, so the event detection module 120 is optional.

The pixel classification module 150 classifies a current pixel into a suitable area, and includes the first classification module 151 and a second classification module 152.

The first classification module 151 determines whether the current pixel belongs to a confident background region, using the Gaussian mixture model initialized by the background model initialization module 130. This determination is made according to whether a Gaussian distribution in which the current pixel is included in a predetermined range exists among a plurality of Gaussian distributions. The confident background region denotes an area that can be confidently determined as a background. In other words, areas that are not clearly determined as either a background or a moving object, such as a shadow, a highlight, and the like, are not included in the confident background region.

To scrutinize such a first classification process, first, K Gaussian distributions learned through the background model initialization process are prioritized according to a value of ωᵢ/σᵢ. If it is assumed that characteristics of a background model are effectively ascertained from a predetermined number of Gaussian distributions having higher priorities among the K Gaussian distributions, the predetermined number, B, is calculated using Equation 4:

$$B = {arg min}_{b} ( {\sum }_{j = 1}^{b} {ω}_{j} > T ) \qquad ( 4 )$$

wherein T denotes a critical value indicating a minimal reliability to the background. If a small number is selected as the value T, a background model is typically implemented as a single mode. In this case, the use of a single optimal distribution reduces the amount of calculation. On the other hand, if the value T is large, the background model includes one or more colors. For example, the background model includes at least two separated colors due to a transparent effect generated by leaves of a tree, a flag fluttering in the wind, an emergency light indicating construction work, or the like.

When the current pixel is checked according to a first classification rule, it is determined whether a difference between the current pixel and a mean of the B Gaussian models exceeds M times the standard deviation σᵢ of a Gaussian model corresponding to the current pixel. If Gaussian models not exceeding M times the standard deviation exist, the current pixel is included in the confident background region. Otherwise, it is determined that the current pixel is not included in the confident background region. The basis of this determination is expressed in Equation 5:

$${\vert x - {μ}_{i} \vert}_{∀ {μ}_{i} , i \leq B} < M \cdot {σ}_{i} \qquad ( 5 )$$

As a result, Equation 5 is an equation determining whether the current pixel is included in a predetermined range, [μᵢ−Mσᵢ, μᵢ+Mσᵢ], of the B Gaussian distributions having high priorities among the K Gaussian distributions. For example, if K is 3 as illustrated in FIG. 7, and B is calculated to have a value of 2 according to Equation 4, it is determined whether the current pixel is included in a gray area of either a first or second Gaussian distribution. Here, M is a real number serving as a basis of determining whether the current pixel is included in a Gaussian distribution. The M value may be about 2.5. As the M value increases, a loose boundary which increases a probability of determining that the current pixel is included in the background area is produced. On the other hand, as the M value decreases, a compact boundary which decreases the probability of determining that the current pixel is included in the background area is produced.

In the present invention, pixels are classified into corresponding areas in two classification stages. Since only pixels belonging to the confident background area must be selected in the first classification stage, the first classification stage preferably, though not necessarily, uses the compact boundary as a boundary of the background model. Hence, instead of being fixed to 2.5, the M value may be smaller than 2.5 in many cases, according to the characteristics of a video image.

When it is determined by the first classification module 151 that the current pixel is not included in the confident background, the second classification module 152 performs a second classification stage on the current pixel. When a change due to a shadow and a highlight occurs, the luminance values of pixels decrease or increase whereas the color values of the pixels do not change. In this embodiment of the present invention, the current pixel not determined to be included in the confident background region is classified into a moving object area F, a shadow area S, or a highlight area H.

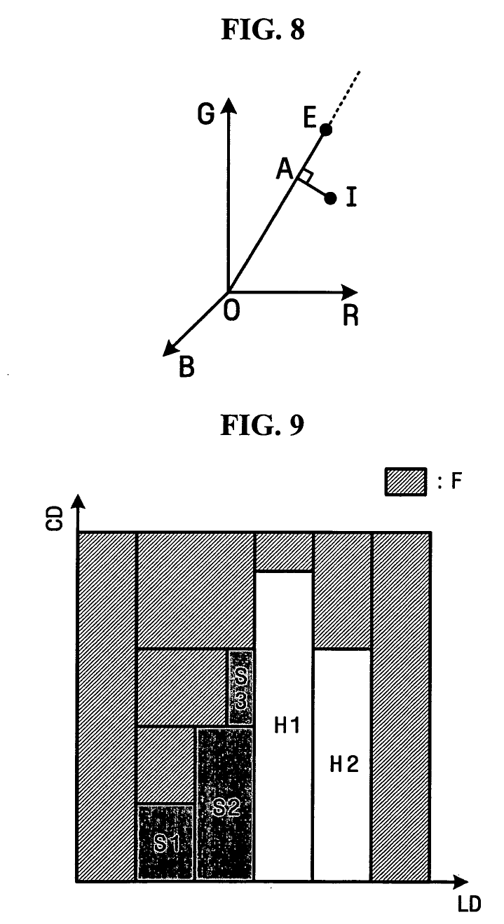

To perform the second classification stage, first, an RGB color of a current pixel (I), as illustrated in FIG. 8, is divided into two components, which are a luminance distortion (LD) component and a chrominance distortion (CD) component. In FIG. 8, E, which is an expected value of the current pixel (I), denotes a mean of a Gaussian distribution for a background corresponding to the location of the current pixel (I). A line OE ranging from the origin O to the point E is referred to as an expected chrominance line.

LD can be calculated using Equation 6:

$$LD = {{argmin}_{z} ( I - zE )}^{2} \qquad ( 6 )$$

wherein a value z at point A makes the line OE and a line Al cross at a right angle. When the luminance of the current pixel (I) is equal to an expected value, the LD is 1. When the luminance of the current pixel (I) is smaller than the expected value, LD is less than 1. When the luminance of the current pixel (I) is greater than the expected value, LD is more than 1.

CD is defined as the distance between the current pixel (I) and a chrominance line (OE) for the current pixel as expressed in Equation 7:
CD=∥I−LD×E∥ (7)

The second classification module 152 sets a coordinate plane having an x axis indicating LD and a y axis indicating CD, demarcates classification areas F, S, and H on the coordinate plane, and determines which area the current pixel belongs to.

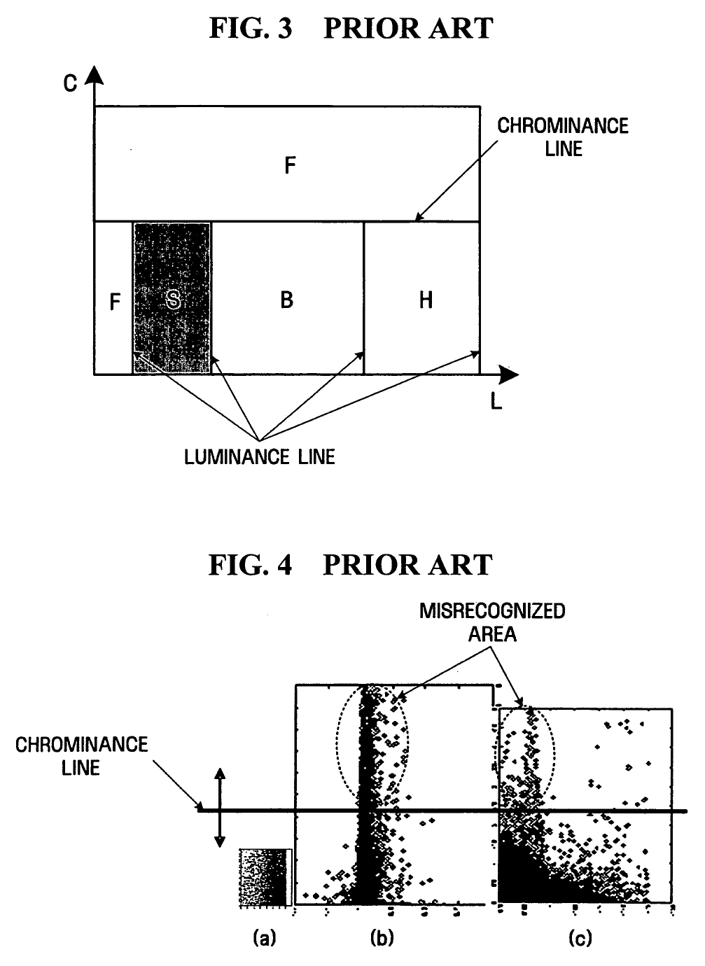

FIG. 9 is a classification area table obtained by demarcating classification areas on an LD-CD coordinate plane according to this embodiment of the present invention. Compared with the area classification table in the conventional Horprasert method of FIG. 3, upper limit lines of the CD component that distinguish the moving object area F from other areas in a vertical direction are not fixed to a uniform line, but are set differently for different areas. The areas S and H are sub-divided into areas S1, S2, S3, H1, and H2. Pixels not classified as being in the confident background region by the first classification module 151 are classified into the moving object area F, the shadow area S, or the highlight area H by the second classification module 152. This classification contributes to ascertaining exact characteristics of the current pixel.

In the classification area table of FIG. 9, the sub-divided area H1 denotes a highlight area, and the sub-divided area H2 denotes an area that is made bright due to an ON operation of the automatic iris of a camera. The sub-divided areas S1, S2, and S3 may be pure shadow areas or areas that become dark due to an OFF operation of the automatic iris. There is no need to clarify whether the dark area is generated either by a shadow or by a function of the automatic iris. According to a pattern formed by an experiment involving this embodiment of the present invention, the important thing is that a dark area can be classified into three sub-divided areas S1, S2, and S3 according to the characteristics of the dark area.

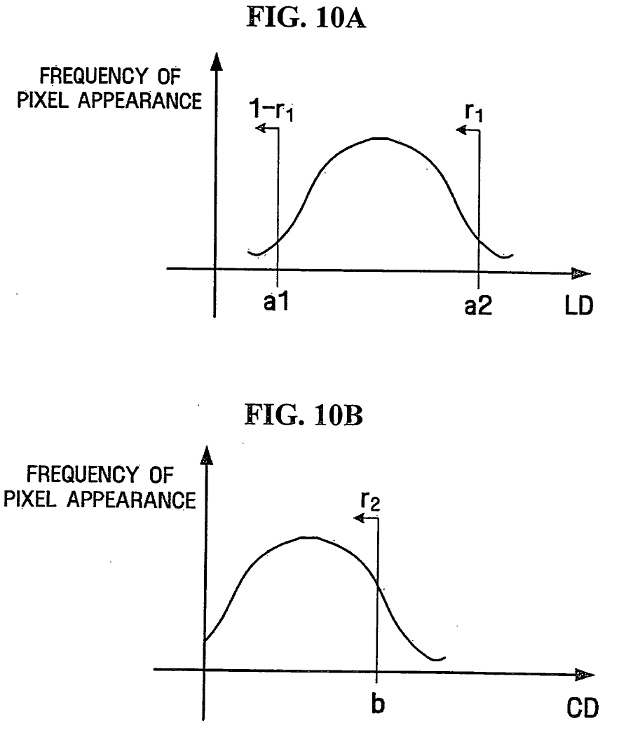

As described above, although rough shapes of the sub-divided areas S1, S2, S3, H1, and H2 are set, critical values of the sub-divided areas in an x-axis direction and in a y-axis direction may vary according to characteristics of the observed image. A method of setting a critical value of each sub-divided area will now be described in greater detail. Basically, each sub-divided area forms a histogram based on statistics, and then the critical value of each sub-divided area is set based on a predetermined sensing rate r. The setting of the critical value of each sub-divided area will be specified with reference to FIGS. 10A and 10B.

FIG. 10A is a graph showing the frequency of appearance of pixels based on LD. An upper limit critical value a2 is set so that a percentage of all samples occupied by samples not exceeding the upper limit critical value a2 is r₁. A lower limit critical value a1 is set so that a percentage of all samples occupied by samples not exceeding the lower limit critical value a1 is 1−r₁. If r is 0.9, the upper limit critical value a2 is set to a point where the percentage not exceeding the upper limit critical value a2 is 0.9, and the lower limit critical value a1 is set to a point where the percentage not exceeding the lower limit critical value a1 is 0.1.

FIG. 10B is a graph showing the frequency of appearance of pixels based on CD. Since only an upper limit critical value b exists in CD, the upper limit critical value b is set so that a percentage of all samples occupied by samples not exceeding the upper limit critical value b is r₂ (e.g., 0.6). When critical values of the sub-divided areas are determined based on LD and CD using the method illustrated in FIGS. 10A and 10B, a classification area table as shown in FIG. 9 can be completed.

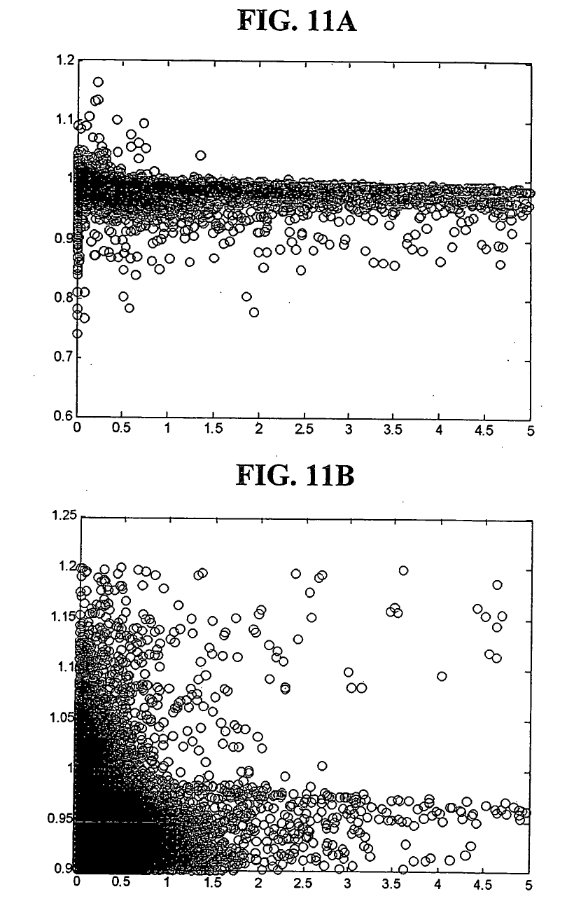

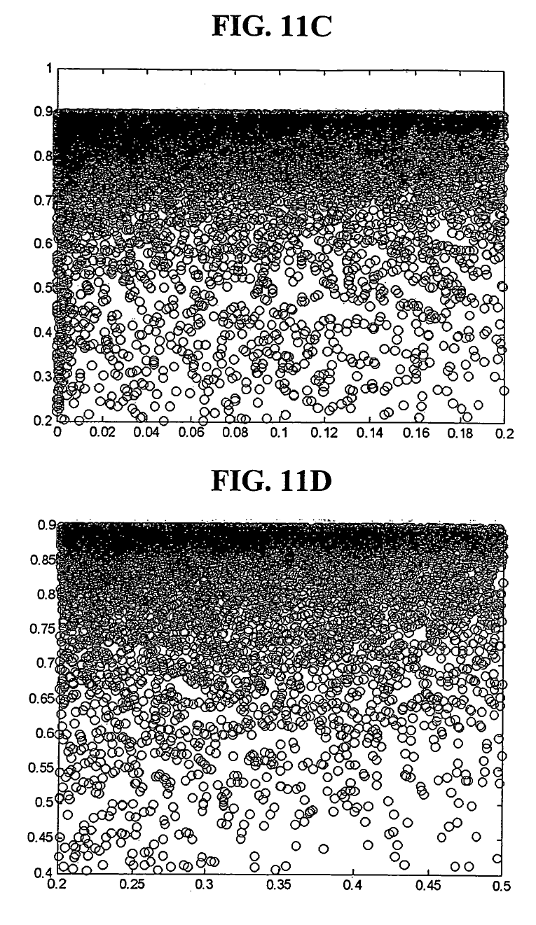

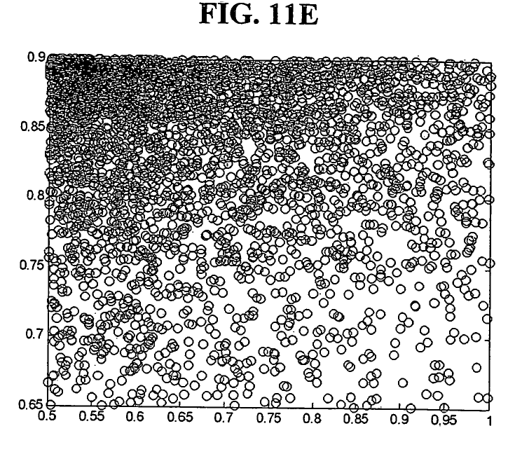

FIGS. 11A through 11E are graphs illustrating examples of sample distributions for the individual sub-divided areas H1, H2, S1, S2, and S3.

In FIGS. 11A through 11E, the x-axis represents CD, and the y-axis represents LD. FIG. 11A illustrates a result of a sample test for obtaining the sub-divided area H1, and FIG. 11B illustrates a result of a sample test for obtaining the sub-divided area H2. Although the areas of FIGS. 11A and 11B may overlap at some portions, as shown in FIGS. 11A and 11B, the areas of FIGS. 11A and 11B are both defined as a highlight area. Hence, in the present embodiment, the area H1 is defined first, and then the area H2 is defined in an area not overlapped by the area H1. In other words, the overlapped portions are included in the area H1.

FIG. 11C illustrates a result of a sample test for obtaining the sub-divided area S1, FIG. 11D illustrates a result of a sample test for obtaining the sub-divided area S2, and FIG. 11E illustrates a result of a sample test for obtaining the sub-divided area S3. To demarcate the sub-divided areas S1, S2, and S3 within the shadow area, the area S2 is defined first, and then the areas S1 and S3 are defined in an area not overlapped by the area S2.

Values r₁ and r₂ of FIGS. 10A and 10B are determined based on test results as shown in FIGS. 11A through 11E, thereby completing a classification area table such as Table 2.

TABLE 2

| Sub-divided areas | Critical values of LD | Critical values of CD |
|---|---|---|
| H1 | [0.9, 1.05] | [0, 4.5] |
| H2 | [1.05, 1.15] | [0, 2.5] |
| S1 | [0.5, 0.65] | [0, 0.2] |
| S2 | [0.65, 0.9] | [0, 0.5] |
| S3 | [0.75, 0.9] | [0.5, 1] |

It can be seen from several experiments that although the critical values in Table 2 vary according to the type of image, the number of sub-divided areas and the shapes of the sub-divided areas may be applied regardless of circumstances, such as the place (indoor, outdoor, and the like) and the time (in the morning, in the afternoon, and the like), as long as the quality of a received video image is not extremely bad.

Table 3 shows results of operations of the first and second classification modules 151 and 152 on received pixels having specific properties. Although all pixels are ultimately determined as either a background or a moving object, if a received pixel is a background pixel, the received pixel is determined to belong to one of the Gaussian mixture models by the first classification module 151. Hence, the received pixel is classified into a background area. An area that is affected by an ON or OFF operation of the automatic iris, a shadow area, and a highlight area are classified into the background area by the second classification module 152.

TABLE 3

| | Input | | | | | | | |
|---|---|---|---|---|---|---|---|---|
| | | ON operation | OFF operation | | | Light | Light | Moving |
| Result | Background | of automatic iris | of automatic iris | Shadow | Highlight | on | off | object |
| Background area | V | V | V | V | V | | | |
| Moving object area | | | | | | V | V | V |
| Sub-divided areas | GMM | H2 | S2 | S1 | H1 | F | F | F |
| | | | S3 | S2 | | | | |
| | | | | S3 | | | | |

As described above, when an event, such as a light being turned on or off, occurs, an error may occur during the classifications by the first and second classification modules 151 and 152. Accordingly, the moving object extracting apparatus 100 includes the event detection module 120. When an event occurs, the event detection module 120 instructs the background model initialization module 130 to initialize a new background model, thereby preventing generation of an error.

Referring back to FIG. 5, the background model updating module 140 updates in real-time the Gaussian mixture models initialized by the background model initialization module 130, using a result of the first classification by the first classification module 151. When a current pixel is classified as being in the confident background region during the first classification, parameters of the current pixel are updated in real time. When the current pixel is not classified as being in the confident background region during the first classification, some of the Gaussian mixture models are changed. In the former case, a weight ωᵢ, a mean μᵢ, and a covariance Σᵢ of a Gaussian distribution in which the current pixel is included are updated using Equation 8:

$$\begin{matrix}{ω}_{i}^{N + 1} = ( 1 - α ) {ω}_{i}^{N} + α \\ {μ}_{i}^{N + 1} = ( 1 - α ) {μ}_{i}^{N} + ρ {x}_{N + 1} \\ {\sum }_{i}^{N + 1} = ( 1 - α ) {Σ}_{i}^{N} + ρ ( {x}_{N + 1} - {μ}_{k}^{N + 1} ) {( {x}_{N + 1} - {μ}_{k}^{N + 1} )}^{T} \\ ρ = αη ( {x}_{N + 1} , {μ}_{i}^{N} , {Σ}_{i}^{N} )\end{matrix} \qquad ( 8 )$$

wherein N denotes an index indicating the frequency of updates, i denotes an index indicating one of the Gaussian mixture models, and a denotes α learning rate. The learning rate α is a positive real number in the range of 0 to 1. When the learning rate α is large, an existing background model is quickly changed by (and therefore sensitively responds to) a newly input image. When the learning rate α is small, the existing background model is slowly changed by (and therefore insensitively responds to) the newly input image. Considering this property, the learning rate a may be appropriately set by a user.

As described above, all parameters of the Gaussian distribution in which the current pixel is included among the K Gaussian distributions are updated. However, as for the remaining K-1 Gaussian distributions, only a weight ωᵢ is updated, as in Equation 9:
ωᵢ^{N+1}=(1−α)ωᵢ^{N} (9)

Hence, the sum of the weights of the Gaussian mixture models is 1 even after updating.

In the latter case where the current pixel is not classified as being in the confident background region during the first classification, the current pixel is not included in any of the K Gaussian distributions. Here, a Gaussian distribution having the lowest priority in terms of ωᵢ/σᵢ among the K Gaussian distributions is replaced by a Gaussian distribution having, as initial values, a mean value set to the value of the current pixel, a sufficiently high covariance, and a sufficiently low weight. Since the new Gaussian distribution has a small value of ωᵢ/σᵢ, it has a low priority.

A circumstance in which a pixel newly appears in a background, and then disappears from the background after a predetermined period of time, is now considered. In this case, the newly appeared pixel is not included in any of the existing Gaussian mixture models, so the Gaussian model having the lowest priority among the existing Gaussian mixture models is replaced by a new model having a mean set to the value of the current pixel. Thereafter, the new pixel will be consecutively detected from the same location on the background for a while. Hence, the weight of the new model gradually increases, and the covariance thereof gradually decreases. Consequently, the priority of the new model heightens, and the new model may be included in the B models having high priorities selected by the first classification module 151. When the pixel starts moving after the predetermined period of time, the priority of the new model is gradually lowered and is finally replaced by a newer model. In this way, the moving object extracting apparatus 100 adaptively reacts to such a special circumstance, thereby extracting moving objects in real time.

Referring back to FIG. 5, the memory 160 stores a collection of pixels finally classified as a moving object on a current image by the first and second classification modules 151 and 152. The pixel collection is referred to as a moving object cluster. Thereafter, a user can output the moving object cluster stored in the memory 160, that is, an extracted moving object image, through the display module 170.

In the specification of the present invention, the term ‘module’, as used herein, referes to, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

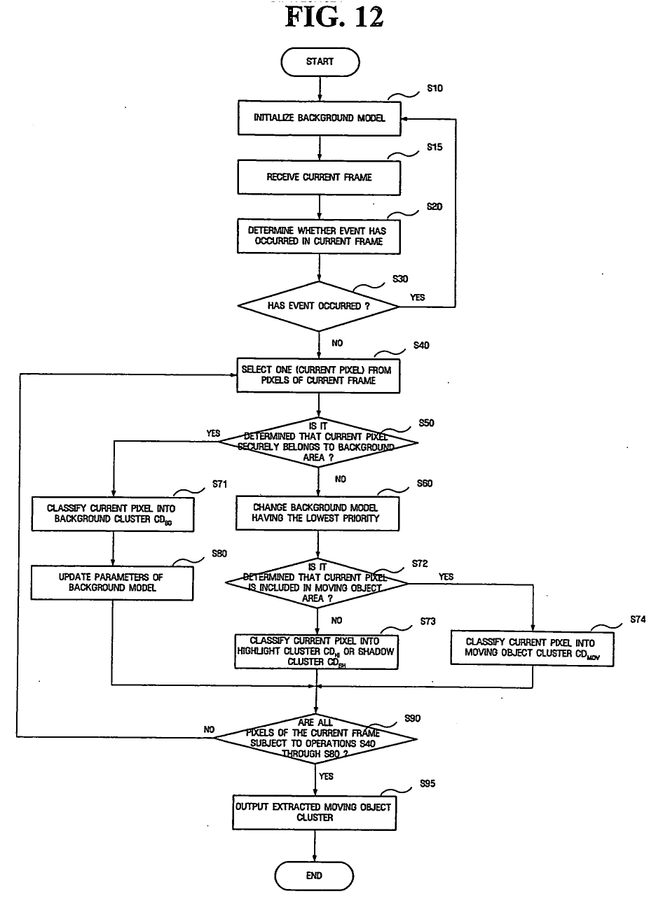

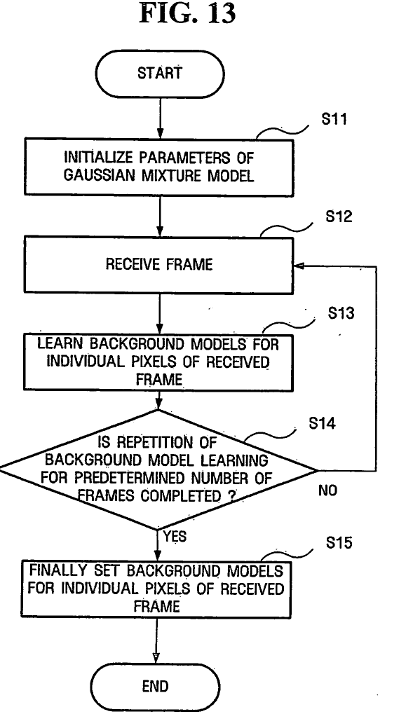

FIG. 12 is a flowchart illustrating an operation of the moving object extracting apparatus 100 of FIG. 5. First, in operation S10, a background model is initialized by the background model initialization module 130. Operation S10 will be detailed later with reference to FIG. 13. When the background model is completely initialized, a frame (image) from which a moving object is to be extracted (hereinafter, referred to as a current frame) is received via the pixel sensing module 110, in operation S15.

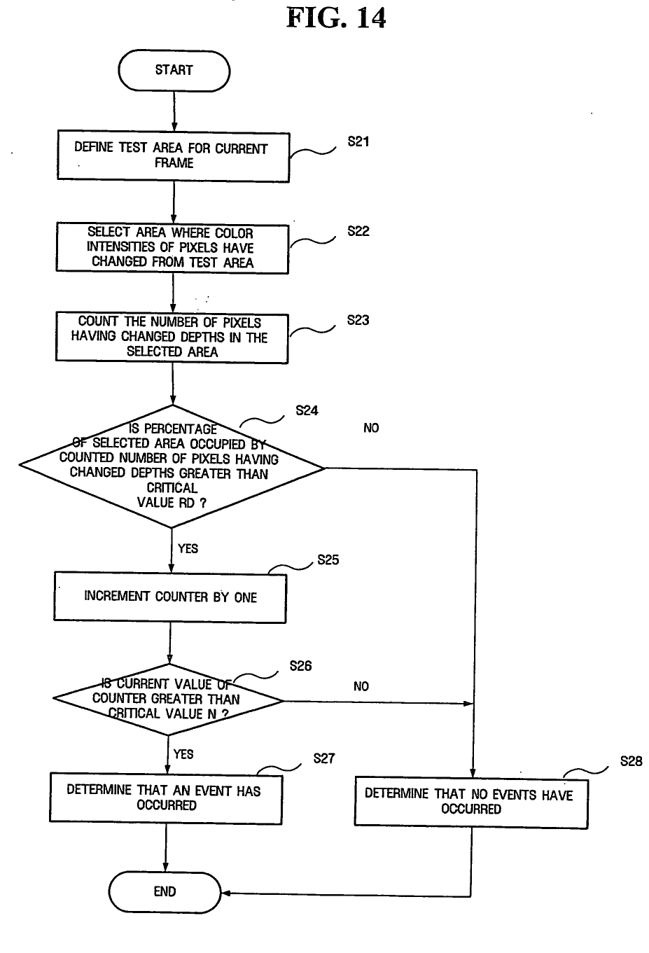

Thereafter, in operation S20, a determination as to whether an event has occurred in the received frame is made by the event detection module 120. Operation S20 will be detailed later with reference to FIG. 14. If it is determined in operation S30 that an event has occurred, the method is fed back to operation S10 to initialize a new background model for an image in which an event has occurred, because the existing background model cannot be used. On the other hand, if it is determined in operation S30 that no events have occurred, a pixel (hereinafter, referred to as a current pixel) is selected from the current frame in operation S40. The current pixel is subject to operation S50 and operations subsequent to S50.

More specifically, in operation S50, it is determined, using the first classification module 151, whether the current pixel belongs to a confident background area. This determination is made depending on whether a difference between the current pixel and a mean of B Gaussian models having high priorities exceeds M times the standard deviation of a Gaussian model corresponding to the current pixel.

If it is determined in operation S50 that the current pixel belongs to a confident background area, the current pixel is classified into a background cluster CDBG, in operation S71. Then, parameters of a background model are updated by the background model updating module 140, in operation S80.

If it is determined in operation S50 that the current pixel does not belong to the confident background area, a background model having the lowest priority is changed, in operation S60. In operation S60, a Gaussian distribution having the lowest priority at the time is replaced by a Gaussian distribution having a mean set to a value of the current pixel, a high covariance, and a low weight as initial parameter values.

After the lowest priority background model is changed, in operation S72 it is determined in the second classification module 152 whether the current pixel is included in the moving object area. This determination depends on which one of the areas F, H1, H2, S1, S2, and S3 on the classification area table having two axes, LD and CD, the current pixel belongs to. If it is determined in operation 72 that the current pixel is included in the moving object area, that is, the current pixel is included in the area F, the current pixel is classified into a moving object cluster CD_{MOV}, in operation 74. If it is determined in operation 72 that the current pixel is included in the area H1 or H2, the current pixel is classified into a highlight cluster CD_{HI}, in operation 73. If it is determined in operation 72 that the current pixel is included in the area S1, S2, or S3, the current pixel is classified into a shadow cluster CD_{SH}, in operation 73.

When it is determined in operation S90 that all pixels of the current frame have been subject to operations S40 through S80, an extracted moving object cluster is output to a user through the display module 170. On the other hand, when it is not determined in operation S90 that all pixels of the current frame are subject to operations S40 through S80, a next pixel of the current frame is subject to operations S40 through S90.

FIG. 13 is a flowchart illustrating the background model initialization operation S10. In operation S11, parameters ωᵢ, μᵢ, and Σᵢ of a Gaussian mixture model are initialized by the background model initialization module 130. If a similar image already exists, parameter values of the similar image may be used as the initial parameter values of the Gaussian mixture model. Alternatively, the initial parameter values may be determined by a user based on his or her experiences, or may be determined randomly.

Thereafter, a frame is received by the pixel sensing module 110, in operation S12. Then, in operation S13, background models for individual pixels of the received frame are learned by the background model initialization module 130. The background model learning repeats for a predetermined number of frames, the value of which is represented by “MinLearnFrames”. The background model learning is achieved by updating the initialized parameters for a predetermined number of frames. The parameter updating is performed in the same manner as the background model parameter updating operation S80. If it is determined in operation S14 that the repetition of the background model learning for the predetermined number of frames “uMinLearnFrames” is completed, the background models for the individual pixels of the received frame are finally set, in operation S15.

FIG. 14 is a flowchart illustrating the event detection operation S20 by the event detection module 120. First, in operation S21, a test area for the current frame is defined. Then, in operation S22, an area where color intensities of pixels have changed is selected from the test area. In operation S23, the number of pixels having changed depths in the selected area is counted. In operation S24, it is determined whether a percentage of the selected area occupied by the counted number of pixels having changed depths is greater than a critical value rd. If the percentage is greater than the critical value rd, a counter value is incremented by one, in operation S25. If it is determined in operation S26 that a current counter value is greater than a critical value N, it is determined that an event has occurred, in operation S27. On the other hand, if the percentage is smaller than or equal to the critical value rd, the counter value is not incremented, and if the current counter value is smaller than or equal to the critical value N, it is determined that no events have occurred, in operation S28.

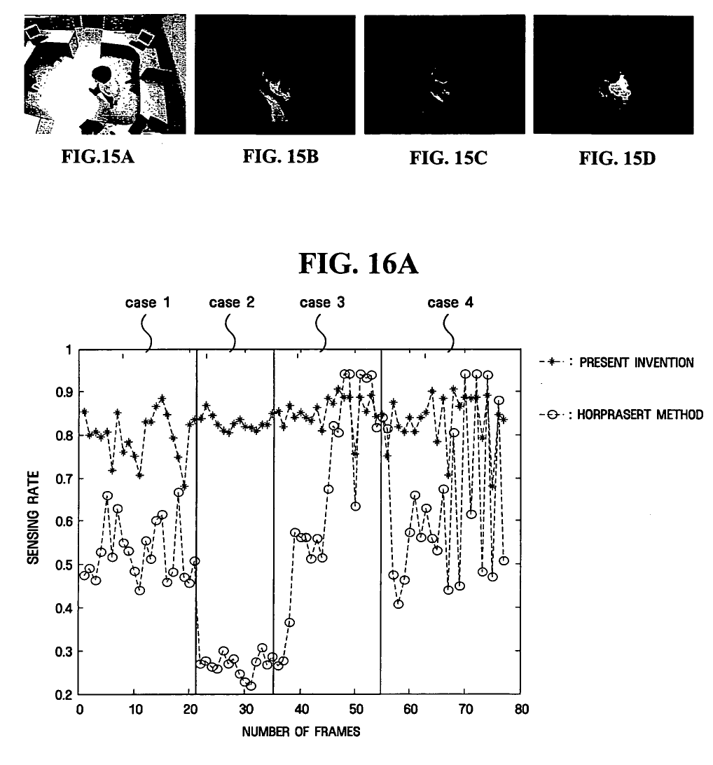

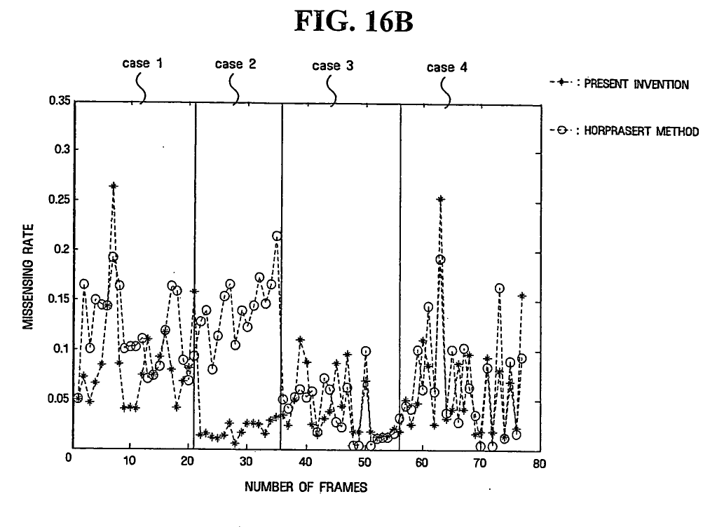

FIGS. 15A-15D and 16A-16B illustrate results obtained by comparing the conventional art to the present invention. FIGS. 15A-15D illustrate a result of an experiment carried out according to an embodiment of the present invention, in addition to the extraction results of FIG. 2. FIG. 15D is an image extracted under the same experimental conditions as the experimental conditions of FIG. 2 according to a moving object extracting method of the present invention. The extracted image of FIG. 15D is excellent compared to conventional images of FIGS. 15B and 15C that were extracted using the compact boundary and the loose boundary, respectively, in the Stauffer method. In other words, the result of the present invention excludes misrecognition of a shadow area as a moving object as in FIG. 15B and misrecognition of a part of the moving object as a background as in FIG. 15C.

FIGS. 16A and 16B are graphs showing results of experiments comparing the method according to an embodiment of the present invention and a conventional Horprasert method under several circumstances. In the experiments of FIGS. 16A and 16B, 80 frames classified into four types of environments are manually checked and labeled, and sensing rates and missensing rates in both methods are then obtained. The four environments are indicated by case 1 through case 4. Case 1 represents an outdoor environment where sunlight is strong and a shadow is clear. Case 2 represents an indoor environment where colors of a moving object and a background look similar. Case 3 represents an environment where an automatic iris of a camera operates in a room. Case 4 represents an environment where an automatic iris of a camera does not operate in a room. A sensing rate denotes a percentage of pixels labeled as a moving object that correspond to pixels actually sensed as the moving object. A missensing rate denotes a percentage of pixels actually sensed as a moving object that do not correspond to pixels labeled as the moving object.

FIG. 16A shows a comparison of sensing rates between the method according to an embodiment of the present invention and the conventional Horprasert method.

Referring to FIG. 16A, the sensing rates of the method according to this embodiment of the present invention in all four cases are excellent. Particularly, the effect of this embodiment of the present invention is prominent in case 2.

FIG. 16B shows a comparison of missensing rates between the method according to this embodiment of the present invention and the conventional Horprasert method.

Referring to FIG. 16B, the two methods have similar results in cases 3 and 4. However, experimental results of the method according to this embodiment of the present invention in cases 1 and 2 are excellent. Particularly, an experimental result of this embodiment of the present invention in case 2 is superb.

According to the present invention, a moving object can be more accurately and adaptively extracted from video images observed in various environments.

Also, a visual system, such as video monitoring, traffic monitoring, person counting, and video edition, can be operated more efficiently.

Although a few embodiments of the present invention have been shown and described, it would be appreciated by those skilled in the art that changes may be made in these embodiments without departing from the principles and spirit of the invention, the scope of which is defined in the claims and their equivalents.

1. A pixel classification device to automatically separate a moving object area from a received video image, the device comprising:
a pixel sensing module to capture the video image;
a first classification module to determine, according to Gaussian models, whether a current pixel of the video image belongs to a confident background region; and
a second classification module to determine which one of a plurality of sub-divided shadow areas, a plurality of sub-divided highlight areas, and the moving object area the current pixel belongs to, in response to a determination that the current pixel of the video image does not belong to the confident background region.

2. The pixel classification device of claim 1, wherein the Gaussian models are Gaussian mixture models.

3. The pixel classification device of claim 2, wherein the current pixel is determined to be included in the confident background region or not according to whether a difference between the current pixel and a mean of a predetermined number of Gaussian models having high priorities among the Gaussian mixture models exceeds a predetermined multiplier of a standard deviation of a model corresponding to the current model.

4. The pixel classification device of claim 3, wherein the multiplier is determined so that a boundary of a Gaussian model is a compact boundary.

5. The pixel classification device of claim 1, wherein the sub-divided shadow areas, the sub-divided highlight areas, and the moving object area are defined on a coordinate plane having a luminance distortion (LD) axis and a chrominance distortion (CD) axis, the luminance distortion given by LD=arg min(I−zE)² and the chrominance distortion given by CD=∥I−LD×E∥, wherein I denotes a value of the current pixel, and E denotes a value expected at a location of the current pixel.

6. The pixel classification device of claim 5, wherein the sub-divided shadow areas are S1, S2, and S3, and the sub-divided highlight areas are H1 and H2.

7. The pixel classification device of claim 6, wherein the sub-divided areas S1, S2, S3, H1, and H2 are defined by two critical values on the luminance distortion axis and one critical value on the chrominance distortion axis based on a predetermined sensing rate.

8. A moving object extracting apparatus comprising:
a background model initialization module to initialize parameters of a Gaussian mixture model of a background and to learn the Gaussian mixture model during a predetermined number of frames of a video image;
a first classification module to determine whether a current pixel belongs to a confident background region according to whether the current pixel is included in the Gaussian mixture model;
a second classification module to determine which one of a plurality of sub-divided shadow areas, a plurality of sub-divided highlight areas, and a moving object area the current pixel belongs to, in response to a determination being made that the current pixel does not belong to the confident background region; and
a background model updating module to update the Gaussian mixture model in real time according to a result of the determination as to whether the current pixel belongs to the confident background region.

9. The moving object extracting apparatus of claim 8, further comprising an event detection module to determine whether an abrupt illumination change occurs in a current image and to require the background model initialization module to re-perform initialization in response to the abrupt illumination change being detected in the current image.

10. The moving object extracting apparatus of claim 9, wherein the event detection module selects, from a predetermined test area, an area in which color intensities of pixels have changed, and determines that the abrupt illumination change has occurred in the current image in response to a percentage of the selected area occupied by the number of pixels having the changed color intensities being greater than a critical value rd.

11. The moving object extracting apparatus of claim 10, wherein the event detection module selects from the predetermined test area the area in which the color intensities of pixels have changed, increases a counter value in response to a percentage of the selected area occupied by the number of pixels having the changed color intensities being greater than the critical value rd, and determines that the abrupt illumination change has occurred in the current image in response to the counter value being greater than a critical value N.

12. The moving object extracting apparatus of claim 8, wherein the learning is performed on an image having a fixed background.

13. The moving object extracting apparatus of claim 8, wherein the background model updating module updates a weight ωᵢ, a mean μᵢ, and a covariance Σᵢ of a Gaussian mixture model in which the current pixel is included, and updates only a weight ωᵢ of a Gaussian mixture model in which the current pixel is not included.

14. The moving object extracting apparatus of claim 8, wherein, in response to the determination that the current pixel is not classified into the confident background region, the background pixel updating module replaces a Gaussian distribution having a lowest priority by a Gaussian distribution having, as initial values, a mean set to the value of the current pixel, a correspondingly high covariance, and a correspondingly low weight.

15. A pixel classification method of automatically separating a moving object area from a received video image, the method comprising:
capturing the video image;
determining, according to Gaussian models, whether a current pixel of the video image belongs to a confident background region; and
determining which one of a plurality of sub-divided shadow areas, a plurality of sub-divided highlight areas, and the moving object area the current pixel belongs to, in response to a determination that the current pixel of the video image does not belong to the confident background region.

16. The pixel classification method of claim 15, wherein whether the current pixel is determined to be included in the confident background region or not according to whether a difference between the current pixel and a mean of a predetermined number of Gaussian models having high priorities among the Gaussian mixture models exceeds a predetermined multiplier of a standard deviation of a model corresponding to the current model.

17. The pixel classification method of claim 15, wherein the sub-divided shadow areas are S1, S2, and S3, and the sub-divided highlight areas are H1 and H2.

18. The pixel classification method of claim 15, wherein the sub-divided areas S1, S2, S3, H1, and H2 are defined, on a coordinate plane having a luminance distortion axis and a chrominance distortion axis, by two critical values on the luminance distortion axis and one critical value on the chrominance distortion axis based on a predetermined sensing rate.

19. A moving object extracting method comprising:
initializing parameters of a Gaussian mixture model of a background and learning the Gaussian mixture model during a predetermined number of frames of a video image;
determining whether a current pixel belongs to a confident background region according to whether the current pixel is included in the Gaussian mixture model;
determining which one of a plurality of sub-divided shadow areas, a plurality of sub-divided highlight areas, and the moving object area the current pixel belongs to, in response to a determination being made that the current pixel does not belong to the confident background region; and
updating the Gaussian mixture model in real time according to a result of the determination as to whether the current pixel belongs to the confident background region.

20. The moving object extracting method of claim 19, further comprising an event detection module determining whether an abrupt illumination change occurs in a current image and requiring the background model initialization module to re-perform initialization in response to the abrupt illumination change being detected in the current image.

21. A pixel classification device to separate a moving object area from a video image, the device comprising:
a first classification unit to determine whether a current pixel of the video image belongs to a confident background region; and
a second classification unit to determine which one of a plurality of sub-divided background areas or the moving object area the current pixel belongs to in response to a determination that the current pixel does not belong to the confident background region.

22. The pixel classification device of claim 21, wherein the first classification unit determines whether the current pixel of the video image belongs to the confident background region according to Gaussian models.

23. The pixel classification device of claim 22, wherein the Gaussian models are Gaussian mixture models.

24. The pixel classification device of claim 21, wherein the plurality of sub-divided background areas comprises sub-divided shadow areas and/or sub-divided highlight areas.

25. A pixel classification method of separating a moving object area from a video image, the method comprising:
determining whether a current pixel of the video image belongs to a confident background image; and
determining which one of a plurality of sub-divided background areas or the moving object area the current pixel belongs to in response to a determination that the current pixel of the video image does not belong to the confident background region.

26. The method of claim 25, wherein the determining whether the current pixel of the video image belongs to the confident background region is performed according to Gaussian models.

27. The method of claim 26, wherein the Gaussian models are Gaussian mixture models.

28. The pixel classification device of claim 25, wherein the plurality of sub-divided background areas comprises sub-divided shadow areas and/or sub-divided highlight areas.
